(19) United States
(12) Patent Application Publication
(10) Pub. No.: US 2025/0118108 A1
(43) Pub. Date: Apr. 10, 2025

(54) EMOTION PORTRAYAL DATABASE

(71) Applicant: Texas State University, San Marcos, TX (US)

(72) Inventors: Maria Resendiz, Austin, TX (US); Damian Valles, San Marcos, TX (US)

(21) Appl. No.: 18/911,537

(22) Filed: Oct. 10, 2024

Related U.S. Application Data
(60) Provisional application No. 63/543,451, filed on Oct. 10, 2023.

(51) Int. Cl. G06V 40/20; G06N 20/00; G06V 40/16

(52) U.S. Cl. CPC G06V 40/20; G06N 20/00; G06V 40/174

(57) ABSTRACT

A computer-implemented method, computer program product, and system for developing an emotion portrayal database that improves training machine learning models to identify emotions. Videos containing facial expressions, audio information, and gestural demonstrations of individuals demonstrating an emotion are received. Examples of such emotions include angry, disgusted, fearful, happy, neutral, sad, and surprised. The received videos are then curated into video clips containing the facial expressions, audio information, and gestural demonstrations. Labels of an emotion (e.g., happy, sad) to be assigned to the curated video clips for the facial expressions, audio information, and gestural demonstrations are then received. Upon receiving such labels, the curated video clips are assigned their received labels. Each curated video clip for the facial expressions, audio information, and gestural demonstrations with its assigned label is then stored in the emotion portrayal database.

### GOVERNMENT INTERESTS

This invention was made with government support under Grant Numbers 2231794 and 2150135 awarded by the National Science Foundation. The government has certain rights in the invention.

### TECHNICAL FIELD

The present disclosure relates generally to machine learning in identifying emotions, and more particularly to developing a single database containing facial, audio, and gestural information to be used in training machine learning models to identify one of the seven universal emotions.

### BACKGROUND

Recently, machine learning models have been trained to recognize emotions, such as emotions of a face. Such machine learning models attempt to classify the emotion on a person's face into one of seven categories (e.g., angry, disgusted, fearful, happy, neutral, sad, and surprised) based on training the model using a dataset that includes labeled data. For example, such a model may be trained using the FER-2013 dataset, which consists of 35,887 grayscale, 48×48 sized face images with seven emotions—angry, disgusted, fearful, happy, neutral, sad, and surprised. Such images are classified or labeled with a particular emotion. Such labeled data is then used to train the model to classify an emotion of a new image of a person's face. For example, based on the labeled images of persons' expressing a happy emotion, a new image of a person with the same characteristics as such labeled images should also be classified as happy by the model.

Unfortunately, such training data is deficient in that such data only includes limited information. For example, such machine learning models are trained to classify or recognize emotions based only on facial expressions, audio inflections, or gestures, which are each separately stored in a database. That is, such machine learning models are trained from a single database that only contains expressions of emotions based on facial expressions, audio inflections, or gestures.

By training such machine learning models with limited data, such machine learning models are not accurately classifying human emotions.

### SUMMARY

In one embodiment of the present disclosure, a computer-implemented method for developing an emotion portrayal database that improves training machine learning models to identify emotions comprises receiving videos containing facial expressions, audio information, and gestural demonstrations of individuals demonstrating emotions. The method further comprises curating the received videos into video clips containing the facial expressions, the audio information, and the gestural demonstrations. The method additionally comprises receiving a label of an emotion for each curated video clip. Furthermore, the method comprises assigning the label of emotion to each curated video clip with its received label of emotion. Additionally, the method comprises storing each curated video clip with its assigned label of emotion in the emotion portrayal database.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is diagram of the software components used by the emotion learning system to develop an emotion portrayal database that contains facial, audio, and gestural information labeled with emotions that is to be used in training machine learning models to identify one of the seven universal emotions, such as angry, disgusted, fearful, happy, neutral, sad, and surprised, in accordance with an embodiment of the present disclosure;

FIG. 3 illustrates an embodiment of the present disclosure of the hardware configuration of the emotion learning system which is representative of a hardware environment for practicing the present disclosure; and

FIG. 4 is a flowchart of a method for improving the accuracy in training machine learning models to classify human emotions by developing a single database that contains labeled facial, audio, and gestural information to be used in training machine learning models to identify one of the seven universal emotions in accordance with an embodiment of the present disclosure.

### DETAILED DESCRIPTION

As stated in the Background section, recently, machine learning models have been trained to recognize emotions, such as emotions of a face. Such machine learning models attempt to classify the emotion on a person's face into one of seven categories (e.g., angry, disgusted, fearful, happy, neutral, sad, and surprised) based on training the model using a dataset that includes labeled data. For example, such a model may be trained using the FER-2013 dataset, which consists of 35,887 grayscale, 48×48 sized face images with seven emotions—angry, disgusted, fearful, happy, neutral, sad, and surprised. Such images are classified or labeled with a particular emotion. Such labeled data is then used to train the model to classify an emotion of a new image of a person's face. For example, based on the labeled images of persons' expressing a happy emotion, a new image of a person with the same characteristics as such labeled images should also be classified as happy by the model.

Unfortunately, such training data is deficient in that such data only includes limited information. For example, such machine learning models are trained to classify or recognize emotions based only on facial expressions, audio inflections, or gestures, which are each separately stored in a database. That is, such machine learning models are trained from a single database that only contains expressions of emotions based on facial expressions, audio inflections, or gestures.

By training such machine learning models with limited data, such machine learning models are not accurately classifying human emotions.

The embodiments of the present disclosure provide a means for improving the accuracy in training machine learning models to classify human emotions by developing a single database that contains facial, audio, and gestural information labeled with an emotion, where such information is used in training machine learning models to identify one of the seven universal emotions, such as angry, disgusted, fearful, happy, neutral, sad, and surprised. Furthermore, such data (facial, audio, and gestural information) was labeled with emotions based on how people would interpret the emotions as opposed to having the person who demonstrated the emotion identify the emotion they are portraying. A further description of these and other features will be provided below.

In some embodiments of the present disclosure, the present disclosure comprises a computer-implemented method, system, and computer program product for developing an emotion portrayal database that improves training machine learning models to identify emotions. In one embodiment, videos containing facial expressions, audio information, and gestured demonstrations of individuals demonstrating an emotion are received. A facial expression, as used herein, is one or more motions or positions of the muscles beneath the skin of the face. Audio information, as used herein, refers to any sound or auditory impression perceived by the ears and processed by the brain. Gestural demonstrations, as used herein, refer to a movement of a part of the body, especially a hand or the head, to express an idea or meaning. In one embodiment, such demonstrators of emotions in the videos may correspond to non-actors in order to obtain real-world examples of such emotions. Such received videos are then curated into video clips containing the facial expressions, the audio information, and the gestural demonstrations. Curating, as used herein, refers to creating short video clips containing facial expressions, audio information, and gestural demonstrations to be assigned a label. A label, as used herein, refers to a tag that forms a representation of what class of objects the data belongs to (e.g., sad, happy) and helps a machine learning model learn to identify that particular class of objects when encountered in data without a tag. In one embodiment, a model is built and trained to identify the video clips containing facial expressions, audio information, and gestural demonstrations to be curated from the videos. Furthermore, a label of an emotion (e.g., one of the seven universal emotions, such as angry, disgusted, fearful, happy, neutral, sad, and surprised) for each curated video clip is received and then assigned to the curated video clip. In one embodiment, such labels to be assigned to each curated video clip are identified by users other than those who have demonstrated the emotion. In this manner, such data is labeled with an emotion based on how people would interpret the emotions as opposed to having the person who demonstrated the emotion identify the emotion they are portraying. In one embodiment, a model is built sand trained to identify the labels (labels of seven universal emotions, such as angry, disgusted, fearful, neutral, sad, and surprised) to be assigned to each curated video clip. Upon assigning such labels of emotions to the curated video clips, such curated video clips with their assigned labels of emotion are stored in the emotion portrayal database. In this manner, since the emotion portrayal database contains labeled facial, audio, and gestural information as opposed to simply labeled facial information, a machine learning model may be more effectively trained to classify human emotions. That is, the emotion portrayal database can now provide facial, audio, and gestural information labeled with one of the seven universal emotions, which can be used to more effectively train machine learning models for social emotion learning.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

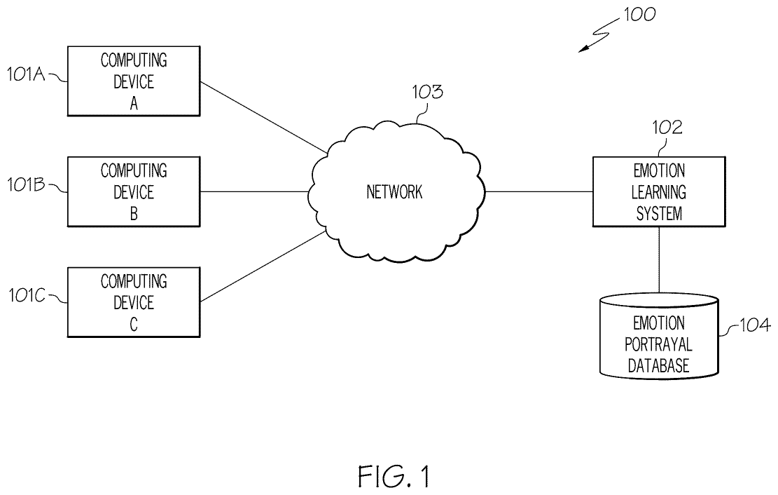

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to an emotion learning system 102 via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance, and the like) configured with the capability of connecting to network 103 and consequently communicating with other computing devices 101 and emotion learning system 102. It is noted that both computing device 101 and the user of computing device 101 may be identified with element number 101.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Emotion learning system 102 is configured to develop an emotion portrayal database 104 which contains facial, audio, and gestural information labeled with emotions that is to be used in training machine learning models to identify one of the seven universal emotions, such as angry, disgusted, fearful, happy, neutral, sad, and surprised. Facial information, as used herein, refers to information pertaining to facial expressions. A facial expression, as used herein, is one or more motions or positions of the muscles beneath the skin of the face. Audio information, as used herein, refers to any sound or auditory impression perceived by the ears and processed by the brain. Gestural information, as used herein, refers to gestural demonstrations. Gestural demonstrations, as used herein, refer to a movement of a part of the body, especially a hand or the head, to express an idea or meaning. In one embodiment, emotion portrayal database 104 is connection to emotion learning system 102.

In one embodiment, emotion learning system 102 is configured to receive videos containing facial expressions, audio information, and gestured demonstrations of individuals demonstrating an emotion. Such demonstrators may correspond to non-actors in order to obtain real-world examples of such emotions.

Furthermore, in one embodiment, emotion learning system 102 is configured to curate such received videos into video clips for the facial expressions, audio information, and gestural demonstrations. Curating, as used herein, refers to creating short video clips containing facial expressions, audio information, and gestural demonstrations to be assigned a label. A label, as used herein, refers to a tag that forms a representation of what class of objects the data belongs to (e.g., sad, happy) and helps a machine learning model learn to identify that particular class of objects when encountered in data without a tag.

Additionally, in one embodiment, emotion learning system 102 is configured to receive a label of an emotion to be assigned to each curated video clip for the facial expression, audio information, and gestural demonstrations. In one embodiment, such labels are assigned to each curated video clip by users other than those who have demonstrated the emotion. In this manner, such data is labeled with an emotion based on how people would interpret the emotions as opposed to having the person who demonstrated the emotion identify the emotion they are portraying.

In one embodiment, such labels are used to assign one of the seven universal emotions, such as angry, disgusted, fearful, happy, neutral, sad, and surprised, to the curated video clip. In one embodiment, users of computing devices 101 assign labels to a curated video clip tagging such video clips with an emotion, such as one of the seven universal emotions. In one embodiment, such labels are then sent to emotion learning system 102 from the user of computing device 101 via network 103.

In one embodiment, upon receiving the labels for the curated video clips from users, such as the users of computing devices 101, emotion learning system 102 assigns each curated video clip for the facial expression, audio information, and gestural demonstrations with its received label. For example, curated video clip #1 may have been labeled with the emotion of “angry” by one or more users of computing devices 101. Such a label may then be assigned to curated video clip #1 by emotion learning system 102.

The curated video clip with its assigned label may then be stored in emotion portrayal database 104 by emotion learning system 102.

Since emotion portrayal database 104 contains labeled facial, audio, and gestural information as opposed to simply labeled facial information, a machine learning model may be more effectively trained to classify human emotions.

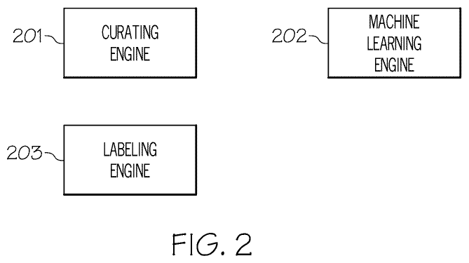

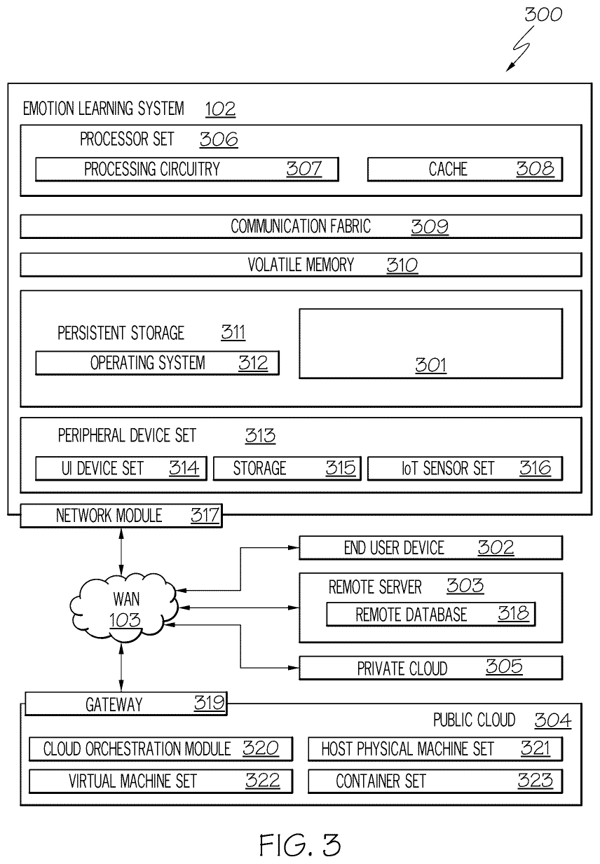

A description of the software components of emotion learning system 102 used for developing an emotion portrayal database 104 that contains facial, audio, and gestural information labeled with emotions that is to be used in training machine learning models to identify one of the seven universal emotions, such as angry, disgusted, fearful, happy, neutral, sad, and surprised, is provided below in connection with FIG. 2. A description of the hardware configuration of emotion learning system 102 is provided further below in connection with FIG. 3.

System 100 is not to be limited in scope to any one particular network architecture. System 100 may include any number of computing devices 101, emotion learning systems 102, networks 103, and databases 104.

A discussion regarding the software components used by emotion learning system 102 to develop an emotion portrayal database 104 that contains facial, audio, and gestural information labeled with emotions that is to be used in training machine learning models to identify one of the seven universal emotions, such as angry, disgusted, fearful, happy, neutral, sad, and surprised, is provided below in connection with FIG. 2.

FIG. 2 is diagram of the software components used by emotion learning system 102 to develop an emotion portrayal database 104 that contains facial, audio, and gestural information labeled with emotions that is to be used in training machine learning models to identify one of the seven universal emotions, such as angry, disgusted, fearful, happy, neutral, sad, and surprised, in accordance with an embodiment of the present disclosure.

Referring to FIG. 2, in conjunction with FIG. 1, emotion learning system 102 includes curating engine 201 configured to receive videos containing facial expressions, audio information, and gestured demonstrations of individuals demonstrating an emotion.

A facial expression, as used herein, is one or more motions or positions of the muscles beneath the skin of the face. Audio information, as used herein, refers to any sound or auditory impression perceived by the ears and processed by the brain. Gestural demonstrations, as used herein, refer to a movement of a part of the body, especially a hand or the head, to express an idea or meaning.

In one embodiment, such demonstrators of emotions in the videos may correspond to non-actors in order to obtain real-world examples of such emotions.

In one embodiment, such videos of demonstrators of emotions, which include facial expressions, audio information, and gestured demonstrations, are captured using standard video cameras (e.g., Sony® FX30, Sony® HDR-CX405 Handycam®, Panasonic® HC-VX981K Camcorder, etc.). Such videos may then be transmitted to emotion learning system 102 via network 103.

For example, in one embodiment, such videos containing facial expressions, audio information, and gestured demonstrations of individuals demonstrating an emotion are obtained by interviewing individuals, such as non-actors. The interviews consist of two major sections: a demographic survey section and an interview session. Participants are instructed to demonstrate each of the seven universal emotions (e.g., happy, sad, angry, fear, neutral, surprised, disgust) at the beginning and end of the interview. Four types of questions (e.g., elicitation, narration, description, comparison) are utilized as prompts to record emotional portrayal in conversation. Videos of the interviews are then uploaded to a database, such as database 104.

Furthermore, in one embodiment, curating engine 201 curates such received videos into video clips containing facial expressions, audio information, and gestural demonstrations.

Curating, as used herein, refers to creating short video clips containing facial expressions, audio information, and gestural demonstrations to be assigned a label. A label, as used herein, refers to a tag that forms a representation of what class of objects the data belongs to (e.g., sad, happy) and helps a machine learning model learn to identify that particular class of objects when encountered in data without a tag.

Emoting learning system 102 further includes machine learning engine 202 configured to build and train a model to identify the video clips containing facial expressions, audio information, and gestural demonstrations to be curated from the videos.

In one embodiment, machine learning engine 202 trains the model to identify the video clips containing facial expressions, audio information, and gestural demonstrations to be curated from the videos based on a sample data set that includes video clips from videos containing facial expressions, audio information, and gestural demonstrations. Such a sample data set may be stored in a data structure (e.g., table) residing within the storage device of emotion learning system 102. In one embodiment, such a data structure is populated by an expert.

Furthermore, in one embodiment, the sample data set discussed above is referred to herein as the “training data,” which is used by a machine learning algorithm to make predictions or decisions as to the video clips containing facial expressions, audio information, and gestural demonstrations to be curated from the videos. The algorithm iteratively makes predictions on the training data as to the curated video clips until the predictions achieve the desired accuracy as determined by an expert. Examples of such learning algorithms include nearest neighbor, Naïve Bayes, decision trees, linear regression, support vector machines, and neural networks.

After training a model to identify the video clips containing facial expressions, audio information, and gestural demonstrations to be curated from the videos, such a trained model is used to identify the video clips containing facial expressions, audio information, and gestural demonstrations to be curated from the received videos.

In one embodiment, prior to curating the videos containing facial expressions, audio information, and gestured demonstrations, interviewee questions and remarks are removed from the videos. Each participant's answer for each question is exported as a single video clip. In one embodiment, the curated video clips are organized into two categories: facial and speech models. For example, initial and final demonstrations of each emotion are utilized as facial models. Emotion portrayals in conversation are utilized as speech models.

In one embodiment, prior to curating the received videos into video clips containing the facial expressions, audio information, and gestural demonstrations, such videos are preprocessed. In one embodiment, preprocessing considers the size of each dataset, the combination of the datasets, contrast enhancements, brightness adjustments, and split curation of the subjects for training and testing of the models. In one embodiment, the received videos include videos captured in color videos. In such an example, the frames per emotions are also considered to be in red, green, and blue (RGB) format. In one embodiment, such videos are preprocessed by transforming such samples to grayscale for their contrast and brightness adjustments for the data augmentation.

In one embodiment, the first enhancement to each image sample is to convert the image to a grayscale 8-bit image and apply the Contrast Limited Adaptive Histogram Equalization (CLAHE) using OpenCV to reduce the noise when amplifying and distributing the histogram of the image. In one embodiment, the clip limit is set to 2.0, and the tile grid size is set to 8×8. In one embodiment, the CLAHE image is saved and replaced with the original image as the central sample for its indicated emotion. In one embodiment, the image is then increased in brightness by two levels at 1.5 and 1.75 with OpenCV. Finally, in one embodiment, the image is decreased in brightness by two levels at 0.5 and 0.25 with OpenCV. Each brightness changes are saved as a separate image sample and saved with a similar original file name in order to properly split the samples for the training and testing phases of the models.

In one embodiment, the model trained to identify the video clips containing facial expressions, audio information, and gestural demonstrations to be curated from the videos based on a sample data set that includes video clips from videos containing facial expressions, audio information, and gestural demonstrations corresponds to a convolutional neural network (CNN)-based model, such as Visual Geometry Group (VGG)16, Naïve-CNN, EfficientNetV2, and MobileNetV2.

Visual Geometry Group (VGG) is a convolutional neural network that uses 3×3 convolutional filters. In one embodiment, VGG16 is utilized to identify the video clips to be curated from the videos, where the 16 represents the number of trainable layers in the network. In one embodiment, VGG16 is implemented using Python 3.8.10 with TensorFlow® 2.9.1.

In one embodiment, the VGG16 utilized by the present disclosure includes three convolutional layers, followed by batch normalization, max pooling, and dropout layers. The convolutional layers have 32, 64, and 128 filters with “ReLU” activation functions. After each pair of convolutional layers, max pooling is used to reduce the spatial dimensions, and dropout layers are employed to mitigate overfitting. The model transitions to a fully connected part composed of two dense layers with 64 neurons and “ReLU” activation functions, accompanied by batch normalization and dropout layers. The output layer is a dense layer with seven neurons corresponding to the number of classes, followed by an activation layer with a “SoftMax” function for multi-class classification.

In one embodiment, the Naïve-CNN model utilized by the present disclosure to identify the video clips containing facial expressions, audio information, and gestural demonstrations to be curated from the videos based on a sample data set that includes video clips from videos containing facial expressions, audio information, and gestural demonstrations includes three convolutional layers, followed by batch normalization and max pooling layers. The convolutional layers have 32, 64, and 128 filters, respectively, with a kernel size of 3×3 and ReLU activation. After the convolutional layers, a flatten layer converts the feature maps into a 1D array, followed by a fully connected dense layer with 512 neurons and “ReLU” activation. A dropout layer with a rate of 0.5 is employed to prevent overfitting. Finally, the output layer consists of a dense layer with as many neurons as the number of classes, utilizing a “SoftMax” activation function for multi-class classification. The model uses image generators to preprocess and feed grayscale images from the train and test directories in batches, set at 32, resizing them to the specified target size and employing categorical labels.

In one embodiment, the EfficientNetV2 model utilized by the present disclosure to identify the video clips containing facial expressions, audio information, and gestural demonstrations to be curated from the videos based on a sample data set that includes video clips from videos containing facial expressions, audio information, and gestural demonstrations is constructed by including the trained EfficientNetB0 model version with no included weights, and average pooling value, and its input shape at 48×48×1. Its batch size is set to 32. The input layer carries the same input shape and feeds into its dense layer of 128 nodes and the “ReLU” activation function. A dropout of 0.5 is introduced before the last dense layer. The output layer has the seven expected outputs with a “SoftMax” activation function.

In one embodiment, the MobileNetV2 model utilized by the present disclosure to identify the video clips containing facial expressions, audio information, and gestural demonstrations to be curated from the videos based on a sample data set that includes video clips from videos containing facial expressions, audio information, and gestural demonstrations has an architecture with layers frozen for learning except for the last five, the last three, then the final layer to check for further learning dimensionality to further explore the degree of understanding of emotion context. Each three-freezing stage approaches a validation accuracy of 90% well before the fifth training epoch.

Emotion learning system 102 additionally includes labeling engine 203 configured to receive a label of an emotion to be assigned to each curated video clip. Labeling engine 203 is further configured to assign each curated video clip with its received label of emotion.

In one embodiment, such labels to be assigned to each curated video clip are identified by users other than those who have demonstrated the emotion. In this manner, such data is labeled with an emotion based on how people would interpret the emotions as opposed to having the person who demonstrated the emotion identify the emotion they are portraying.

In one embodiment, such labels are used to assign one of the seven universal emotions, such as angry, disgusted, fearful, happy, neutral, sad, and surprised, to the curated video clip. In one embodiment, user(s) of computing device(s) 101 identify the labels to be assigned to the curated video clips. In one embodiment, such labels are then sent to labeling engine 203 from the user(s) of computing device(s) 101 via network 103.

In one embodiment, machine learning engine 202 builds and trains a model to identify the labels (labels of seven universal emotions, such as angry, disgusted, fearful, neutral, sad, and surprised) to be assigned to each curated video clip based on a sample data set that includes labels for curated video clips. Such a sample data set may be stored in a data structure (e.g., table) residing within the storage device of emotion learning system 102. In one embodiment, such a data structure is populated by an expert.

Furthermore, in one embodiment, the sample data set discussed above is referred to herein as the “training data,” which is used by a machine learning algorithm to make predictions or decisions as to the labels (labels of seven universal emotions, such as angry, disgusted, fearful, neutral, sad, and surprised) for the curated video clips. The algorithm iteratively makes predictions on the training data as to the labels for the curated video clips until the predictions achieve the desired accuracy as determined by an expert. Examples of such learning algorithms include nearest neighbor, Naïve Bayes, decision trees, linear regression, support vector machines, and neural networks.

Upon training a model to label (labels of seven universal emotions, such as angry, disgusted, fearful, neutral, sad, and surprised) curated video clips, labeling engine 203 uses the trained model to label the emotions in each curated video clip. The output generated by such a trained model is then received by labeling engine 203.

Upon receiving the labels for the curated video clips, such as from users or from the trained model discussed above, labeling engine 203 assigns each curated video clip for the facial expressions, audio information, and gestural demonstrations with its received label. For example, curated video clip #1 may have been labeled with the emotion of “angry” by one or more users of computing devices 101. Such a label may then be assigned to curated video clip #1 by labeling engine 203. By assigning a label of emotion to the curated video clip, such a curated video clip is tagged with an emotion (e.g., happy).

In one embodiment, emotion learning system 102 assigns each curated video clip for the facial expressions, audio information, and gestural demonstrations with its received label using various software tools, which can include, but are not limited to, DemoCreator, Camtasia®, Snagit®, etc.

In one embodiment, labeling engine 203 stores each curated video clip with its assigned label in emotion portrayal database 104.

Since emotion portrayal database 104 contains labeled facial, audio, and gestural information as opposed to simply labeled facial information, a machine learning model may be more effectively trained to classify human emotions.

That is, emotion portrayal database 104 can now provide facial, audio, and gestural information labeled with one of the seven universal emotions, which can be used to more effectively train machine learning models for social emotion learning.

Most current AI-based emotion recognition relies on the machine learning of a large spectrum of human data, drawing from disparate visual, audio, and gestural databases. This approach results in the need to “cleanse” much of this data to yield consistency and relevance for machine consumption. This is due to a key factor: the sampling frequency for each category (visual, audio, and gestural) of these databases can be different, resulting in a single emotion capture (at any point in time) being out-of-sync. The machine then has to interpret and align these signals on a single time scale (under a unified time constant) in addition to data matching between interpreted-to-actual emotions.

In one embodiment, emotion portrayal database 104 of the present disclosure has three separate curations and one with the three combined pieces of information. Currently available databases have the person portraying the emotion provide the label for the emotion; however, the way an emotion is portrayed is not always the way other humans interpret the emotion. While many currently available databases use actors, embodiments of the present disclosure use non-actors to get more real-world examples.

By developing such a database, emotion portrayal database 104 enables the neural engine to focus on the data matching and not waste time and computing power aligning (interpreting) the various databases. As such, emotion portrayal database 104, which corresponds to a unified facial, vocal, and gestural database, offers a singular, real-time, data-capturing approach that is already synced. As a result, the need for data cleansing and preparation is reduced. Less computer power is required. Furthermore, a path to capturing a more diversified human population is offered. Additionally, the principles of the present disclosure can significantly accelerate the cognitive learning process in support of various commercial applications, such as facial recognition, emotion recognition, voice recognition, speaker identification, gesture recognition, human behavior analysis, multimodal fusion, etc.

A further description of these and other functions is provided below in connection with the discussion of the method for improving the accuracy in training machine learning models to classify human emotions by developing a single database that contains labeled facial, audio, and gestural information to be used in training machine learning models to identify one of the seven universal emotions.

Prior to the discussion of the method for improving the accuracy in training machine learning models to classify human emotions by developing a single database that contains labeled facial, audio, and gestural information to be used in training machine learning models to identify one of the seven universal emotions, a description of the hardware configuration of emotion learning system 102 (FIG. 1) is provided below in connection with FIG. 3.

Referring now to FIG. 3, in conjunction with FIG. 1, FIG. 3 illustrates an embodiment of the present disclosure of the hardware configuration of emotion learning system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (computer code for developing an emotion portrayal database, which is stored in block 301) involved in performing the disclosed methods, such as developing an emotion portrayal database that contains labeled facial, audio, and gestural information to be used in training machine learning models to identify one of the seven universal emotions, such as angry, disgusted, fearful, happy, neutral, sad, and surprised. In addition to block 301, computing environment 300 includes, for example, emotion learning system 102, network 103, such as a wide area network (WAN), end user device (EUD) 302, remote server 303, public cloud 304, and private cloud 305. In this embodiment, emotion learning system 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Emotion learning system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically emotion learning system 102, to keep the presentation as simple as possible. Emotion learning system 102 may be located in a cloud, even though it is not shown in a cloud in FIG. 3. On the other hand, emotion learning system 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto emotion learning system 102 to cause a series of operational steps to be performed by processor set 306 of emotion learning system 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 308 and the other storage media discussed below. The program instructions, and associated data, are accessed by processor set 306 to control and direct performance of the disclosed methods. In computing environment 300, at least some of the instructions for performing the disclosed methods may be stored in block 301 in persistent storage 311.

Communication fabric 309 is the signal conduction paths that allow the various components of emotion learning system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM.

Typically, the volatile memory is characterized by random access, but this is not required unless affirmatively indicated. In emotion learning system 102, the volatile memory 310 is located in a single package and is internal to emotion learning system 102, but, alternatively or additionally, the volatile memory may be distributed over multiple packages and/or located externally with respect to emotion learning system 102.

Persistent Storage 311 is any form of non-volatile storage for computers that is now known or to be developed in the future. The non-volatility of this storage means that the stored data is maintained regardless of whether power is being supplied to emotion learning system 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the disclosed methods.

Peripheral device set 313 includes the set of peripheral devices of emotion learning system 102. Data communication connections between the peripheral devices and the other components of emotion learning system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where emotion learning system 102 is required to have a large amount of storage (for example, where emotion learning system 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows emotion learning system 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the disclosed methods can typically be downloaded to emotion learning system 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates emotion learning system 102), and may take any of the forms discussed above in connection with emotion learning system 102. EUD 302 typically receives helpful and useful data from the operations of emotion learning system 102. For example, in a hypothetical case where emotion learning system 102 is designed to provide a recommendation to an end user, this recommendation would typically be communicated from network module 317 of emotion learning system 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to emotion learning system 102. Remote server 303 may be controlled and used by the same entity that operates emotion learning system 102. Remote server 303 represents the machine(s) that collect and store helpful and useful data for use by other computers, such as emotion learning system 102. For example, in a hypothetical case where emotion learning system 102 is designed and programmed to provide a recommendation based on historical data, then this historical data may be provided to emotion learning system 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes software components configured to develop an emotion portrayal database that contains labeled facial, audio, and gestural information to be used in training machine learning models to identify one of the seven universal emotions, such as angry, disgusted, fearful, happy, neutral, sad, and surprised. In one embodiment, such components may be implemented in hardware. The functions performed by such components are not generic computer functions. As a result, emotion learning system 102 is a particular machine that is the result of implementing specific, non-generic computer functions.

In one embodiment, the functionality of such software components of emotion learning system 102, including the functionality for developing an emotion portrayal database that contains labeled facial, audio, and gestural information to be used in training machine learning models to identify one of the seven universal emotions, such as angry, disgusted, fearful, happy, neutral, sad, and surprised, may be embodied in an application specific integrated circuit.

As stated above, recently, machine learning models have been trained to recognize emotions, such as emotions of a face. Such machine learning models attempt to classify the emotion on a person's face into one of seven categories (e.g., angry, disgusted, fearful, happy, neutral, sad, and surprised) based on training the model using a dataset that includes labeled data. For example, such a model may be trained using the FER-2013 dataset, which consists of 35,887 grayscale, 48×48 sized face images with seven emotions—angry, disgusted, fearful, happy, neutral, sad, and surprised. Such images are classified or labeled with a particular emotion. Such labeled data is then used to train the model to classify an emotion of a new image of a person's face. For example, based on the labeled images of persons' expressing a happy emotion, a new image of a person with the same characteristics as such labeled images should also be classified as happy by the model. Unfortunately, such training data is deficient in that such data only includes limited information. For example, such machine learning models are trained to classify or recognize emotions based only on facial expressions, audio inflections, or gestures, which are each separately stored in a database. That is, such machine learning models are trained from a single database that only contains expressions of emotions based on facial expressions, audio inflections, or gestures. By training such machine learning models with limited data, such machine learning models are not accurately classifying human emotions.

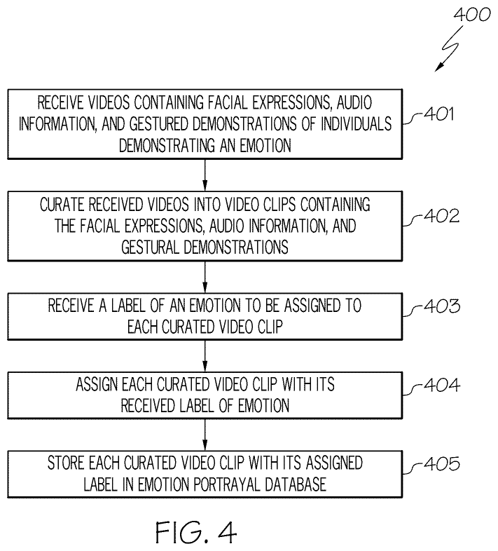

The embodiments of the present disclosure provide a means for improving the accuracy in training machine learning models to classify human emotions by developing a single database that contains labeled facial, audio, and gestural information to be used in training machine learning models to identify one of the seven universal emotions, such as angry, disgusted, fearful, happy, neutral, sad, and surprised, as discussed below in connection with FIG. 4.

FIG. 4 is a flowchart of a method 400 for improving the accuracy in training machine learning models to classify human emotions by developing a single database that contains labeled facial, audio, and gestural information to be used in training machine learning models to identify one of the seven universal emotions in accordance with an embodiment of the present disclosure.

Referring to FIG. 4, in conjunction with FIGS. 1-3, in step 401, curating engine 201 of emotion learning system 102 receives videos containing facial expressions, audio information, and gestured demonstrations of individuals demonstrating an emotion.

As discussed above, a facial expression, as used herein, is one or more motions or positions of the muscles beneath the skin of the face. Audio information, as used herein, refers to any sound or auditory impression perceived by the ears and processed by the brain. Gestural demonstrations, as used herein, refer to a movement of a part of the body, especially a hand or the head, to express an idea or meaning.

In one embodiment, such demonstrators of emotions in the videos may correspond to non-actors in order to obtain real-world examples of such emotions.

In one embodiment, such videos of demonstrators of emotions, which include facial expressions, audio information, and gestured demonstrations, are captured using standard video cameras (e.g., Sony® FX30, Sony® HDR-CX405 Handycam®, Panasonic® HC-VX981K Camcorder, etc.). Such videos may then be transmitted to emotion learning system 102 via network 103.

For example, in one embodiment, such videos containing facial expressions, audio information, and gestured demonstrations of individuals demonstrating an emotion are obtained by interviewing individuals, such as non-actors. The interviews consist of two major sections: a demographic survey section and an interview session. Participants are instructed to demonstrate each of the seven universal emotions (e.g., happy, sad, angry, fear, neutral, surprised, disgust) at the beginning and end of the interview. Four types of questions (e.g., elicitation, narration, description, comparison) are utilized as prompts to record emotional portrayal in conversation. Videos of the interviews are then uploaded to a database, such as database 104.

In step 402, curating engine 201 of emotion learning system 102 curates such received videos into video clips containing facial expressions, audio information, and gestural demonstrations.

As stated above, curating, as used herein, refers to creating short video clips containing facial expressions, audio information, and gestural demonstrations to be assigned a label. A label, as used herein, refers to a tag that forms a representation of what class of objects the data belongs to (e.g., sad, happy) and helps a machine learning model learn to identify that particular class of objects when encountered in data without a tag.

Emoting learning system 102 further includes machine learning engine 202 configured to build and train a model to identify the video clips containing facial expressions, audio information, and gestural demonstrations to be curated from the videos.

In one embodiment, machine learning engine 202 trains the model to identify the video clips containing facial expressions, audio information, and gestural demonstrations to be curated from the videos based on a sample data set that includes video clips from videos containing facial expressions, audio information, and gestural demonstrations. Such a sample data set may be stored in a data structure (e.g., table) residing within the storage device (e.g., storage device 311, 315) of emotion learning system 102. In one embodiment, such a data structure is populated by an expert.

Furthermore, in one embodiment, the sample data set discussed above is referred to herein as the “training data,” which is used by a machine learning algorithm to make predictions or decisions as to the video clips containing facial expressions, audio information, and gestural demonstrations to be curated from the videos. The algorithm iteratively makes predictions on the training data as to the curated video clips until the predictions achieve the desired accuracy as determined by an expert. Examples of such learning algorithms include nearest neighbor, Naïve Bayes, decision trees, linear regression, support vector machines, and neural networks.

After training a model to identify the video clips containing facial expressions, audio information, and gestural demonstrations to be curated from the videos, such a trained model is used to identify the video clips containing facial expressions, audio information, and gestural demonstrations to be curated from the received videos.

In one embodiment, prior to curating the videos containing facial expressions, audio information, and gestured demonstrations, interviewee questions and remarks are removed from the videos. Each participant's answer for each question is exported as a single video clip. In one embodiment, the curated video clips are organized into two categories: facial and speech models. For example, initial and final demonstrations of each emotion are utilized as facial models. Emotion portrayals in conversation are utilized as speech models.

In one embodiment, prior to curating the received videos into video clips containing the facial expressions, audio information, and gestural demonstrations, such videos are preprocessed. In one embodiment, preprocessing considers the size of each dataset, the combination of the datasets, contrast enhancements, brightness adjustments, and split curation of the subjects for training and testing of the models. In one embodiment, the received videos include videos captured in color videos. In such an example, the frames per emotions are also considered to be in red, green, and blue (RGB) format. In one embodiment, such videos are preprocessed by transforming such samples to grayscale for their contrast and brightness adjustments for the data augmentation.

In one embodiment, the first enhancement to each image sample is to convert the image to a grayscale 8-bit image and apply the Contrast Limited Adaptive Histogram Equalization (CLAHE) using OpenCV to reduce the noise when amplifying and distributing the histogram of the image. In one embodiment, the clip limit is set to 2.0, and the tile grid size is set to 8×8. In one embodiment, the CLAHE image is saved and replaced with the original image as the central sample for its indicated emotion. In one embodiment, the image is then increased in brightness by two levels at 1.5 and 1.75 with OpenCV. Finally, in one embodiment, the image is decreased in brightness by two levels at 0.5 and 0.25 with OpenCV. Each brightness changes are saved as a separate image sample and saved with a similar original file name in order to properly split the samples for the training and testing phases of the models.

In one embodiment, the model trained to identify the video clips containing facial expressions, audio information, and gestural demonstrations to be curated from the videos based on a sample data set that includes video clips from videos containing facial expressions, audio information, and gestural demonstrations corresponds to a convolutional neural network (CNN)-based model, such as Visual Geometry Group (VGG)16, Naïve-CNN, EfficientNetV2, and MobileNetV2.

Visual Geometry Group (VGG) is a convolutional neural network that uses 3×3 convolutional filters. In one embodiment, VGG16 is utilized to identify the video clips to be curated from the videos, where the 16 represents the number of trainable layers in the network. In one embodiment, VGG16 is implemented using Python 3.8.10 with TensorFlow® 2.9.1.

In one embodiment, the VGG16 utilized by the present disclosure includes three convolutional layers, followed by batch normalization, max pooling, and dropout layers. The convolutional layers have 32, 64, and 128 filters with “ReLU” activation functions. After each pair of convolutional layers, max pooling is used to reduce the spatial dimensions, and dropout layers are employed to mitigate overfitting. The model transitions to a fully connected part composed of two dense layers with 64 neurons and “ReLU” activation functions, accompanied by batch normalization and dropout layers. The output layer is a dense layer with seven neurons corresponding to the number of classes, followed by an activation layer with a “SoftMax” function for multi-class classification.

In one embodiment, the Naïve-CNN model utilized by the present disclosure to identify the video clips containing facial expressions, audio information, and gestural demonstrations to be curated from the videos based on a sample data set that includes video clips from videos containing facial expressions, audio information, and gestural demonstrations includes three convolutional layers, followed by batch normalization and max pooling layers. The convolutional layers have 32, 64, and 128 filters, respectively, with a kernel size of 3×3 and ReLU activation. After the convolutional layers, a flatten layer converts the feature maps into a 1D array, followed by a fully connected dense layer with 512 neurons and “ReLU” activation. A dropout layer with a rate of 0.5 is employed to prevent overfitting. Finally, the output layer consists of a dense layer with as many neurons as the number of classes, utilizing a “SoftMax” activation function for multi-class classification. The model uses image generators to preprocess and feed grayscale images from the train and test directories in batches, set at 32, resizing them to the specified target size and employing categorical labels.

In one embodiment, the EfficientNetV2 model utilized by the present disclosure to identify the video clips containing facial expressions, audio information, and gestural demonstrations to be curated from the videos based on a sample data set that includes video clips from videos containing facial expressions, audio information, and gestural demonstrations is constructed by including the trained EfficientNetB0 model version with no included weights, and average pooling value, and its input shape at 48×48×1. Its batch size is set to 32. The input layer carries the same input shape and feeds into its dense layer of 128 nodes and the “ReLU” activation function. A dropout of 0.5 is introduced before the last dense layer. The output layer has the seven expected outputs with a “SoftMax” activation function.

In one embodiment, the MobileNetV2 model utilized by the present disclosure to identify the video clips containing facial expressions, audio information, and gestural demonstrations to be curated from the videos based on a sample data set that includes video clips from videos containing facial expressions, audio information, and gestural demonstrations has an architecture with layers frozen for learning except for the last five, the last three, then the final layer to check for further learning dimensionality to further explore the degree of understanding of emotion context. Each three-freezing stage approaches a validation accuracy of 90% well before the fifth training epoch.

In step 403, labeling engine 203 of emotion learning system 102 receives a label of an emotion to be assigned to each curated video clip for the facial expressions, audio information, and gestural demonstrations.

As stated above, in one embodiment, such labels to be assigned to each curated video clip are identified by users other than those who have demonstrated the emotion. In this manner, such data is labeled with an emotion based on how people would interpret the emotions as opposed to having the person who demonstrated the emotion identify the emotion they are portraying.

In one embodiment, such labels are used to assign one of the seven universal emotions, such as angry, disgusted, fearful, happy, neutral, sad, and surprised, to the curated video clip. In one embodiment, user(s) of computing device(s) 101 identify the labels to be assigned to the curated video clips. In one embodiment, such labels are then sent to labeling engine 203 from the user(s) of computing device(s) 101 via network 103.

In one embodiment, machine learning engine 202 builds and trains a model to identify the labels (labels of seven universal emotions, such as angry, disgusted, fearful, neutral, sad, and surprised) to be assigned to each curated video clip based on a sample data set that includes labels for curated video clips. Such a sample data set may be stored in a data structure (e.g., table) residing within the storage device (e.g., storage device 311, 315) of emotion learning system 102. In one embodiment, such a data structure is populated by an expert.

Furthermore, in one embodiment, the sample data set discussed above is referred to herein as the “training data,” which is used by a machine learning algorithm to make predictions or decisions as to the labels (labels of seven universal emotions, such as angry, disgusted, fearful, neutral, sad, and surprised) for the curated video clips. The algorithm iteratively makes predictions on the training data as to the labels for the curated video clips until the predictions achieve the desired accuracy as determined by an expert. Examples of such learning algorithms include nearest neighbor, Naïve Bayes, decision trees, linear regression, support vector machines, and neural networks.

Upon training a model to label (labels of seven universal emotions, such as angry, disgusted, fearful, neutral, sad, and surprised) curated video clips, labeling engine 203 uses the trained model to label the emotions in each curated video clip. The output generated by such a trained model is then received by labeling engine 203.

Upon receiving the labels for the curated video clips, such as from users or from the trained model discussed above, labeling engine 203 assigns each curated video clip for the facial expressions, audio information, and gestural demonstrations with its received label. For example, curated video clip #1 may have been labeled with the emotion of “angry” by one or more users of computing devices 101. Such a label may then be assigned to curated video clip #1 by labeling engine 203. By assigning a label of emotion to the curated video clip, such a curated video clip is tagged with an emotion (e.g., happy).

As stated above, in one embodiment, labeling engine 203 assigns each curated video clip for the facial expressions, audio information, and gestural demonstrations with its received label using various software tools, which can include, but are not limited to, DemoCreator, Camtasia®, Snagit®, etc.

In step 405, labeling engine 203 of emotion learning system 102 stores each curated video clip with its assigned label in emotion portrayal database 104.

Since emotion portrayal database 104 contains labeled facial, audio, and gestural information as opposed to simply labeled facial information, a machine learning model may be more effectively trained to classify human emotions.

That is, emotion portrayal database 104 can now provide facial, audio, and gestural information labeled with one of the seven universal emotions, which can be used to more effectively train machine learning models for social emotion learning.

Most current AI-based emotion recognition relies on the machine learning of a large spectrum of human data, drawing from disparate visual, audio, and gestural databases. This approach results in the need to “cleanse” much of this data to yield consistency and relevance for machine consumption. This is due to a key factor: the sampling frequency for each category (visual, audio, and gestural) of these databases can be different, resulting in a single emotion capture (at any point in time) being out-of-sync. The machine then has to interpret and align these signals on a single time scale (under a unified time constant) in addition to data matching between interpreted-to-actual emotions.

In one embodiment, emotion portrayal database 104 of the present disclosure has three separate curations and one with the three combined pieces of information. Currently available databases have the person portraying the emotion provide the label for the emotion; however, the way an emotion is portrayed is not always the way other humans interpret the emotion. While many currently available databases use actors, embodiments of the present disclosure use non-actors to get more real-world examples.

By developing such a database, emotion portrayal database 104 enables the neural engine to focus on the data matching and not waste time and computing power aligning (interpreting) the various databases. As such, emotion portrayal database 104, which corresponds to a unified facial, vocal, and gestural database, offers a singular, real-time, data-capturing approach that is already synced. As a result, the need for data cleansing and preparation is reduced. Less computer power is required. Furthermore, a path to capturing a more diversified human population is offered. Additionally, the principles of the present disclosure can significantly accelerate the cognitive learning process in support of various commercial applications, such as facial recognition, emotion recognition, voice recognition, speaker identification, gesture recognition, human behavior analysis, multimodal fusion, etc.

Furthermore, the principles of the present disclosure improve the technology or technical field involving machine learning in identifying emotions.

As discussed above, recently, machine learning models have been trained to recognize emotions, such as emotions of a face. Such machine learning models attempt to classify the emotion on a person's face into one of seven categories (e.g., angry, disgusted, fearful, happy, neutral, sad, and surprised) based on training the model using a dataset that includes labeled data. For example, such a model may be trained using the FER-2013 dataset, which consists of 35,887 grayscale, 48×48 sized face images with seven emotions—angry, disgusted, fearful, happy, neutral, sad, and surprised. Such images are classified or labeled with a particular emotion. Such labeled data is then used to train the model to classify an emotion of a new image of a person's face. For example, based on the labeled images of persons' expressing a happy emotion, a new image of a person with the same characteristics as such labeled images should also be classified as happy by the model. Unfortunately, such training data is deficient in that such data only includes limited information. For example, such machine learning models are trained to classify or recognize emotions based only on facial expressions, audio inflections, or gestures, which are each separately stored in a database. That is, such machine learning models are trained from a single database that only contains expressions of emotions based on facial expressions, audio inflections, or gestures. By training such machine learning models with limited data, such machine learning models are not accurately classifying human emotions.

Embodiments of the present disclosure improve such technology by receiving videos containing facial expressions, audio information, and gestured demonstrations of individuals demonstrating an emotion. A facial expression, as used herein, is one or more motions or positions of the muscles beneath the skin of the face. Audio information, as used herein, refers to any sound or auditory impression perceived by the ears and processed by the brain. Gestural demonstrations, as used herein, refer to a movement of a part of the body, especially a hand or the head, to express an idea or meaning. In one embodiment, such demonstrators of emotions in the videos may correspond to non-actors in order to obtain real-world examples of such emotions. Such received videos are then curated into video clips containing the facial expressions, the audio information, and the gestural demonstrations. Curating, as used herein, refers to creating short video clips containing facial expressions, audio information, and gestural demonstrations to be assigned a label. A label, as used herein, refers to a tag that forms a representation of what class of objects the data belongs to (e.g., sad, happy) and helps a machine learning model learn to identify that particular class of objects when encountered in data without a tag. In one embodiment, a model is built and trained to identify the video clips containing facial expressions, audio information, and gestural demonstrations to be curated from the videos. Furthermore, a label of an emotion (e.g., one of the seven universal emotions, such as angry, disgusted, fearful, happy, neutral, sad, and surprised) for each curated video clip is received and then assigned to the curated video clip. In one embodiment, such labels to be assigned to each curated video clip are identified by users other than those who have demonstrated the emotion. In this manner, such data is labeled with an emotion based on how people would interpret the emotions as opposed to having the person who demonstrated the emotion identify the emotion they are portraying. In one embodiment, a model is built sand trained to identify the labels (labels of seven universal emotions, such as angry, disgusted, fearful, neutral, sad, and surprised) to be assigned to each curated video clip. Upon assigning such labels of emotions to the curated video clips, such curated video clips with their assigned labels of emotion are stored in the emotion portrayal database. In this manner, since the emotion portrayal database contains labeled facial, audio, and gestural information as opposed to simply labeled facial information, a machine learning model may be more effectively trained to classify human emotions. That is, the emotion portrayal database can now provide facial, audio, and gestural information labeled with one of the seven universal emotions, which can be used to more effectively train machine learning models for social emotion learning. Furthermore, in this manner, there is an improvement in the technical field involving machine learning in identifying emotions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for developing an emotion portrayal database that improves training machine learning models to identify emotions, comprising:
receiving videos containing facial expressions, audio information, and gestural demonstrations of individuals demonstrating emotions;
curating said received videos into video clips containing said facial expressions, said audio information, and said gestural demonstrations;
receiving a label of an emotion for each curated video clip;
assigning said label of emotion to said each curated video clip with its received label of emotion; and
storing said each curated video clip with its assigned label of emotion in said emotion portrayal database.

2. The method as recited in claim 1, wherein said label of emotion for said each curated video clip is received from one or more users who are not demonstrating said emotion.

3. The method as recited in claim 1, wherein said label of emotion is assigned to said each curated video clip to identify one of seven emotions.

4. The method as recited in claim 3, wherein said seven emotions comprise angry, disgusted, fearful, happy, neutral, sad, and surprised.

5. The method as recited in claim 1, wherein said emotion portrayal database is used to train a machine learning model to identify emotions from inputted video clips.

6. The method as recited in claim 1, wherein said emotions in said videos containing said facial expressions, said audio information, and said gestural demonstrations are demonstrated by non-actors.

7. A computer program product for developing an emotion portrayal database that improves training machine learning models to identify emotions, the computer program product comprising one or more computer readable storage mediums having program code embodied therewith, the program code comprising programming instructions for:
receiving videos containing facial expressions, audio information, and gestural demonstrations of individuals demonstrating emotions;
curating said received videos into video clips containing said facial expressions, said audio information, and said gestural demonstrations;
receiving a label of an emotion for each curated video clip;
assigning said label of emotion to said each curated video clip with its received label of emotion; and
storing said each curated video clip with its assigned label of emotion in said emotion portrayal database.

8. The computer program product as recited in claim 7, wherein said label of emotion for said each curated video clip is received from one or more users who are not demonstrating said emotion.

9. The computer program product as recited in claim 7, wherein said label of emotion is assigned to said each curated video clip to identify one of seven emotions.

10. The computer program product as recited in claim 9, wherein said seven emotions comprise angry, disgusted, fearful, happy, neutral, sad, and surprised.

11. The computer program product as recited in claim 7, wherein said emotion portrayal database is used to train a machine learning model to identify emotions from inputted video clips.

12. The computer program product as recited in claim 7, wherein said emotions in said videos containing said facial expressions, said audio information, and said gestural demonstrations are demonstrated by non-actors.

13. A system, comprising:
a memory for storing a computer program for developing an emotion portrayal database that improves training machine learning models to identify emotions; and
a processor connected to the memory, wherein the processor is configured to execute program instructions of the computer program comprising:
receiving videos containing facial expressions, audio information, and gestural demonstrations of individuals demonstrating emotions;
curating said received videos into video clips containing said facial expressions, said audio information, and said gestural demonstrations;
receiving a label of an emotion for each curated video clip;
assigning said label of emotion to said each curated video clip with its received label of emotion; and
storing said each curated video clip with its assigned label of emotion in said emotion portrayal database.

14. The system as recited in claim 13, wherein said label of emotion for said each curated video clip is received from one or more users who are not demonstrating said emotion.

15. The system as recited in claim 13, wherein said label of emotion is assigned to said each curated video clip to identify one of seven emotions.

16. The system as recited in claim 15, wherein said seven emotions comprise angry, disgusted, fearful, happy, neutral, sad, and surprised.

17. The system as recited in claim 13, wherein said emotion portrayal database is used to train a machine learning model to identify emotions from inputted video clips.

18. The system as recited in claim 3, wherein said emotions in said videos containing said facial expressions, said audio information, and said gestural demonstrations are demonstrated by non-actors.
